(19) United States
(12) Patent Application Publication
(10) Pub. No.: US 2005/0261441 A1
(43) Pub. Date: Nov. 24, 2005

(54) Polyisobutylene composition and cured polyisobutylene product

(76) Inventors: Maneesh Bahadur, Midland, MI (US); Peter Yin Lo, Midland, MI (US); Patrick Vaughn, Lake Orion, MI (US)

Correspondence Address: Dow Corning Corporation;Patent Department - C01232, 2200 W. Salzburg Road, Midland, MI, 48686-0994, US

(21) Appl. No.: 11/080,291

(22) Filed: Mar. 15, 2005

Related U.S. Application Data
(60) Provisional application No. 60/573,422, filed on May 21, 2004.

(51) Int. Cl. C08F 110/00

(52) U.S. Cl. 525/333.7

(57) ABSTRACT

A polyisobutylene composition, comprising (A) a polyisobutylene polymer selected from (i) a glycidoxy-functional polyisobutylene polymer containing an average of at least two glycidoxy groups per molecule having the formula —O—CH₂CH(O)CH₂ and (ii) an alkenyl ether-functional polyisobutylene polymer containing an average of at least two alkenyl ether groups per molecule having the formula —SiR¹ₐ[OR²OC(R³)═CH(R³)]₃₋ₐ, wherein each R¹ is independently C₁ to C₁₀ hydrocarbyl, C₁ to C₁₀ halogen-substituted hydrocarbyl, or C₁ to C₈ alkoxy, R² is C₁ to C₁₀ hydrocarbylene or C₁ to C₁₀ halogen-substituted hydrocarbylene, each R³ is independently C₁ to C₁₀ hydrocarbyl, C₁ to C₁₀ halogen-substituted hydrocarbyl, or —H, subscript a is an integer having a value of 0, 1, or 2, and at least 50 mol % of the repeat units in the polyisobutylene polymer are isobutylene units having the formula: —CH₂C(CH₃)₂—; (B) an epoxy-functional organosiloxane containing from 0.5 to 20% (w/w) silicon, an average of at least two siloxane linkages per molecule, and an average of at least two epoxy groups per molecule; and (C) a catalytic amount of a cationic photoinitiator. And a cured polyisobutylene product prepared by curing the polyisobutylene composition.

### CROSS-REFERENCE TO RELATED APPLICATIONS

This application claims the benefit of U.S. Provisional Application No. 60/573,422, filed May 21, 2004.

### FIELD OF THE INVENTION

The present invention relates to a polyisobutylene composition and more particularly to a radiation-curable polyisobutylene composition containing an epoxy-functional organosiloxane. The present invention also relates to a cured polyisobutylene product prepared by curing the polyisobutylene composition.

### BACKGROUND OF THE INVENTION

Radiation-curable polyisobutylene compositions comprising alkenyl ether-functional or glycidoxy-functional polyisobutylene polymers are known in the art. For example, U.S. Pat. No. 6,242,058 B 1 to Bahadur et al. discloses a radiation-curable composition comprising an alkenyl ether-functional polyisobutylene, a cationic photoinitiator and, optionally, a free radical photoinitiator and/or an alkenyl ether compound which is free of isobutylene units.

U.S. Pat. No. 6,069,185 to Bahadur et al. discloses a radiation-curable composition comprising an alkenyl ether-functional polyisobutylene, a cationic photoinitiator, and a free radical photoinitiator.

U.S. Pat. No. 5,977,255 to Li et al. teaches a method for curing a hydrocarbon polymer having at least two glycidoxy groups in its molecule, said method comprising reacting the hydrocarbon polymer with a curing amount of an organosilicon compound having at least two nitrogen-bonded hydrogen atoms as well as at least one silicon-bonded group selected from —R or —OR in its molecule, wherein R is selected from alkyl radicals having 8 to 18 carbon atoms or alkenyl radicals having 8 to 18 carbon atoms.

U.S. Patent Application Publication No. U.S. 2002/0028303 A1 to Bahadur et al. discloses a radiation-curable composition comprising an alkenyl ether-functional polyisobutylene, a cationic photoinitiator, and a miscible reactive diluent selected from a difunctional vinyl ether reactive diluent, an acrylate reactive diluent, a monofunctional vinyl ether reactive diluent, and an epoxy-functional reactive diluent.

Although the preceding references disclose polyisobutylene compositions that cure to form products having a range of physical and chemical properties, there remains a need for a radiation-curable polyisobutylene composition that cures to form a product having reduced tack, improved oil resistance, and superior mechanical properties.

### SUMMARY OF THE INVENTION

The present invention is directed to a polyisobutylene composition, comprising:
(A) a polyisobutylene polymer selected from (i) a glycidoxy-functional polyisobutylene polymer containing an average of at least two glycidoxy groups per molecule having the formula —CH₂CH(O)CH₂ and (ii) an alkenyl ether-functional polyisobutylene polymer containing an average of at least two alkenyl ether groups per molecule having the formula —SiR¹ₐ[OR²OC(R³)═CH(R³)]₃₋ₐ, wherein each R¹ is independently C₁ to C₁₀ hydrocarbyl, C₁ to C₁₀ halogen-substituted hydrocarbyl, or C₁ to C₈ alkoxy, R² is C₁ to C₁₀ hydrocarbylene or C₁ to C₁₀ halogen-substituted hydrocarbylene, each R³ is independently C₁ to C₁₀ hydrocarbyl, C₁ to C₁₀ halogen-substituted hydrocarbyl, or —H, subscript a is an integer having a value of 0, 1, or 2, and at least 50 mol % of the repeat units in the polyisobutylene polymer are isobutylene units having the formula: —CH₂C(CH₃)₂—;
(B) an epoxy-functional organosiloxane containing from 0.5 to 20% (w/w) silicon, an average of at least two siloxane linkages per molecule, and an average of at least two epoxy groups per molecule; and
(C) a catalytic amount of a cationic photoinitiator.

The present invention is also directed to a cured polyisobutylene product prepared by curing the aforementioned polyisobutylene composition.

The polyisobutylene composition of the present invention can be conveniently formulated as a one-part composition. Moreover, the polyisobutylene composition has good shelf-stability in the absence of light. Importantly, the composition can be applied to a substrate by convention high-speed methods such as spin coating, printing, and spraying. Also, the polyisobutylene composition cures rapidly upon exposure to radiation, e.g., ultraviolet light.

The cured polyisobutylene product prepared by curing the polyisobutylene composition of the present invention exhibits properties characteristic of both silicones and polyisobutylenes. For example, the cured polyisobutylene product exhibits high oil resistance (low oil swell), high tensile strength, high modulus, low surface tack, and low permeability to water and oxygen. Moreover, the cured polyisobutylene product has good primerless adhesion to a variety of substrates, good optical clarity at low wavelengths, and high thermal stability.

The polyisobutylene composition of the present invention, which forms a cured polyisobutylene product, has numerous uses, including protective coatings, encapsulants, and adhesives. In particular, the polyisobutylene composition is useful for bonding components in electronic or electro-optic devices to flexible or rigid substrates.

These and other features, aspects, and advantages of the present invention will become better understood with reference to the following description and appended claims.

### DETAILED DESCRIPTION OF THE INVENTION

As used herein, the “mol %” of isobutylene units in a polyisobutylene polymer is defined as the ratio of the number of moles of isbobutylene units to the total number of moles of repeat units in the polymer, multiplied by 100. Also, the term “repeat units” refers to the non-terminal, i.e., internal, units in the polyisobutylene polymer. Also, the term “% (w/w) silicon” is defined as the ratio of the weight of silicon in the organosiloxane to the total weight of the organosiloxane, multiplied by 100. Further, the term “epoxy group” refers to a monovalent organic group in which an oxygen atom is directly attached to two adjacent or non-adjacent carbon atoms of a carbon chain or ring system. Still further, the term “glycidoxy” refers to a group having the formula: 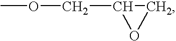
which can also be represented as —O—CH₂CH(O)CH₂.

A radiation-curable polyisobutylene composition according to the present invention, comprises:
(A) a polyisobutylene polymer selected from (i) a glycidoxy-functional polyisobutylene polymer containing an average of at least two glycidoxy groups per molecule having the formula —CH₂CH(O)CH₂ and (ii) an alkenyl ether-functional polyisobutylene polymer containing an average of at least two alkenyl ether groups per molecule having the formula —SiR¹ₐ[OR²OC(R³)═CH(R³)]₃₋ₐ, wherein each R¹ is independently C₁ to C₁₀ hydrocarbyl, C₁ to C₁₀ halogen-substituted hydrocarbyl, or C₁ to C₈ alkoxy, R² is C₁ to C₁₀ hydrocarbylene or C₁ to C₁₀ halogen-substituted hydrocarbylene, each R³ is independently C₁ to C₁₀ hydrocarbyl, C₁ to C₁₀ halogen-substituted hydrocarbyl, or —H, subscript a is an integer having a value of 0, 1, or 2, and at least 50 mol % of the repeat units in the polyisobutylene polymer are isobutylene units having the formula: —CH₂C(CH₃)₂—;
(B) an epoxy-functional organosiloxane containing from 0.5 to 20% (w/w) silicon, an average of at least two siloxane linkages per molecule, and an average of at least two epoxy groups per molecule; and
(C) a catalytic amount of a cationic photoinitiator.

Component (A) is at least one polyisobutylene polymer selected from (A)(i) and (A)(ii), each described below.

Component (A)(i) is at least one glycidoxy-functional polyisobutylene polymer containing an average of at least two glycidoxy groups per molecule having the formula —O—CH₂CH(O)CH₂, wherein at least 50 mol % of the repeat units in the polymer are isobutylene units having the formula: —CH₂C(CH₃)₂—.

The glycidoxy groups in the polyisobutylene polymer can be located at terminal, pendant, or both terminal and pendant positions. Typically, at least 50 mol %, alternatively at least 60 mol %, alternatively at least 75 mol %, of the repeat units in the glycidoxy-functional polyisobutylene polymer are isobutylene units having the formula —CH₂C(CH₃)₂—.

The glycidoxy-functional polyisobutylene polymer typically has a number-average molecular weight of from 1,000 to 500,000, alternatively from 1,000 to 100,000, alternatively from 5,000 to 25,000, where the molecular weight is determined by gel permeation chromatography employing a refractive index detector and polyisobutylene standards.

Methods of preparing glycidoxy-functional polyisobutylene polymers are well known in the art, as exemplified in U.S. Pat. No. 5,977,255 to Li et al. For example, glycidoxy-functional polyisobutylene polymers can be prepared by reacting (a) a polyisobutylene polymer containing an average of at least two silanol (Si—OH) groups per molecule with (ii) a glycidoxy-functional alkoxysilane. This reaction is typically carried out by refluxing a solution of (i) and (ii) in an organic solvent in the presence of a catalyst, such as an organotitanate. Methods of preparing silanol-functional polyisobutylenes are well known in the art, as exemplified in U.S. Pat. No. 5,665,823 to Saxena et al., Japanese Patent Publication No. 07-053882 to Kanegafuchi, and Adv. Inorg. Chem., 1995, 42, 147-262 by P. D. Lickiss. Examples of glycidoxy-functional alkoxysilanes include, but are not limited to, 3-glycidoxypropyltrimethoxysilane. Alternatively, glycidoxy-functional polyisobutylene polymers can be prepared by (1) reacting (a) a polyisobutylene polymer containing an average of at least two allyl or vinyl groups per molecule with (b) a siloxane containing at least two silicon-bonded hydrogen atoms per molecule in the presence of an organic solvent and a hydrosilylation catalyst, to produce an SiH-functional polyisobutylene polymer and (2) reacting the SiH-functional polyisobutylene polymer with an alkenyl glycidyl ether.

Component (A)(ii) is at least one alkenyl ether-functional polyisobutylene polymer containing an average of at least two alkenyl ether groups per molecule having the formula —SiR¹ₐ[OR²OC(R³)═CH(R³)]₃₋ₐ, wherein each R¹ is independently C₁ to C₁₀ hydrocarbyl, C₁ to C₁₀ halogen-substituted hydrocarbyl, or C₁ to C₈ alkoxy, R² is C₁ to C₁₀ hydrocarbylene or C₁ to C₁₀ halogen-substituted hydrocarbylene, each R³ is independently C₁ to C₁₀ hydrocarbyl, C₁ to C₁₀ halogen-substituted hydrocarbyl, or —H, subscript a is an integer having a value of 0, 1, or 2, and at least 50 mol % of the repeat units in the polymer are isobutylene units having the formula: —CH₂C(CH₃)₂—.

The alkenyl ether groups in the polyisobutylene polymer can be located at terminal, pendant, or both terminal and pendant positions. Typically, at least 50 mol %, alternatively at least 60 mol %, alternatively at least 75 mol %, of the repeat units in the alkenyl ether-functional polyisobutylene polymer are isobutylene units having the formula —CH₂C(CH₃)₂—.

The hydrocarbyl and halogen-substituted hydrocarbyl groups represented by R¹ and R³ typically have from 1 to 10 carbon atoms, alternatively from 1 to 6 carbon atoms, alternatively from 1 to 4 carbon atoms. Acyclic hydrocarbyl groups containing at least 3 carbon atoms can have a branched or unbranched structure. Examples of hydrocarbyl groups include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and naphthyl; alkaryl, such as tolyl and xylyl; aralkyl, such as benzyl and phenethyl; alkenyl, such as vinyl, allyl, and propenyl; arylalkenyl, such as styryl and cinnamyl; and alkynyl, such as ethynyl and propynyl. Examples of halogen-substituted hydrocarbyl groups include, but are not limited to, 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

The alkoxy groups represented by R¹ typically have from 1 to 8 carbon atoms, alternatively from 1 to 4 carbon atoms. Examples of alkoxy groups include, but are not limited to, methoxy, ethoxy, propoxy, butoxy, and pentyloxy.

The hydrocarbylene and halogen-substituted hydrocarbylene groups represented by R² typically have from 1 to 10 carbon atoms, alternatively from 1 to 6 carbon atoms, alternatively 1 to 4 carbon atoms. Examples of hydrocarbylene groups include, but are not limited to, alkylene such as methylene, ethylene, propane-1,3-diyl, 2-methylpropane-1,3-diyl, butane-1,4-diyl, butane-1,3-diyl, pentane-1,5,-diyl, pentane-1,4-diyl, hexane-1,6-diyl, octane-1,8-diyl, and decane-1,10-diyl; cycloalkylene such as cyclohexane-14-diyl; arylene such as phenylene. Examples of halogen-substituted hydrocarbylene groups include, but are not limited to, divalent hydrocarbon groups wherein one or more hydrogen atoms have been replaced by halogen, such as fluorine, chlorine, and bromine, such as —CH₂CH₂CF₂CF₂CH₂CH₂—.

Examples of alkenyl ether groups include, but are not limited to, groups having the following formulae: —Si[O(CH₂)₄OCH═CH₂]₃, —SiMe[O(CH₂)₄OCH═CH₂]₂, —SiMe₂[O(CH₂)₄OCH═CH₂], —SiMe [O(CH₂)₄OC(Me)═CH₂], —Si[O(CH₂)₆OCH═CH₂]₃, —SiMe[O(CH₂)₆OCH═CH₂]₂, —SiMe₂[O(CH₂)₆OCH═CH₂], and —SiMe [O(CH₂)₆OC(Me)═CH₂].

The alkenyl ether-functional polyisobutylene polymer typically has a number-average molecular weight of from 1,000 to 500,000, alternatively from 1,000 to 100,000, alternatively from 5,000 to 25,000, where the molecular weight is determined by gel permeation chromatography employing a refractive index detector and polyisobutylene standards.

Methods of preparing alkenyl-ether functional polyisobutylene polymers are well known in the art, as exemplified in U.S. Pat. No. 6,054,549 to Bahadur et al. For example, alkenyl ether-functional polyisobutylene polymers can be prepared by reacting a mixture comprising (a) a polyisobutylene polymer containing an average of at least two groups per molecule having the formula -Z-R⁴ₐSi(OR⁵)₃₋ₐ with (b) an alkenyl ether having the formula HOR²OC(R³)═CH(R³) in the presence of (c) a transesterification catalyst, wherein at least 50 mol % of the repeat units in the polyisobutylene polymer (a) are isobutylene units, R² and R³ are as defined and exemplified above, R⁴ is C₁ to C₁₀ hydrocarbyl or C₁ to C₁₀ halogen-substituted hydrocarbyl, R⁵ is C₁ to C₈ hydrocarbyl or halogen-substituted hydrocarbyl, subscript a is an integer having a value of 0, 1, or 2, and Z is selected from (i) an alkylene group having from 2 to 10 carbon atoms and (ii) a group having the formula: 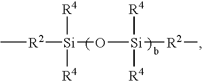
wherein R² and R⁴ are as defined above and subscript b is an integer having a value of from 1 to 5.

The hydrocarbyl and halogen-substituted hydrocarbyl groups represented by R⁴ are as defined and exemplified above for R¹. Also, the alkylene groups represented by Z are as defined and exemplified above for R².

The hydrocarbyl and halogen-substituted hydrocarbyl groups represented by R⁵ typically have from 1 to 8 carbon atoms, alternatively from 1 to 4 carbon atoms. Examples of hydrocarbyl groups include, but are not limited to, unbranched and branched alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, and octyl; cycloalkyl, such as cyclopentyl, cyclohexyl, and methylcyclohexyl; phenyl; alkaryl, such as tolyl and xylyl; and aralkyl, such as benzyl and phenethyl. Examples of halogen-substituted hydrocarbyl groups include, but are not limited to, 3,3,3-trifluoropropyl, 3-chloropropyl, chlorophenyl, and dichlorophenyl.

Component (A) can be a polyisobutylene polymer selected from (A)(i) and (A)(ii), or a mixture comprising (A)(i) and (A)(ii).

The concentration of component (A) in the polyisobutlyene composition of the present invention is typically from 10 to 90% (w/w), alternatively from 30 to 80% (w/w), alternatively form 50 to 60% (w/w), based on the total weight of the composition.

Component (B) is an epoxy-functional organosiloxane containing from 0.5 to 20% (w/w) silicon, an average of at least two siloxane linkages per molecule, and an average of at least two epoxy groups per molecule.

The epoxy-functional organosiloxane typically contains from 0.5 to 20% (w/w) silicon, alternatively from 1 to 10% (w/w) silicon, alternatively from 2 to 5% (w/w) silicon, based on the total weight of the organosiloxane.

The epoxy-functional organosiloxane typically contains an average of at least two siloxane linkages, Si—O—Si per molecule. Alternatively, the expoxy-functional organosiloxane contains an average of from 2 to 10 siloxane linkages per molecule.

The epoxy-functional organosiloxane typically contains an average of at least two epoxy groups. Alternatively, the epoxy-functional organosiloxane contains an average of from 2 to 10 epoxy groups per molecule. The epoxy groups can be located at terminal, pendant, or both terminal and pendant positions in the molecules of the compound.

The epoxy-functional organosiloxane can have a linear, branched, or cyclic structure. Moreover, the organosiloxane typically has molecular weight of from 100 to 5,000, alternatively from 250 to 1,000, alternatively from 250 to 500.

Examples of epoxy-functional organosiloxanes suitable for use as component (B) in the polyisobutylene composition of the present invention, include, but are not limited to, (i) at least one organosiloxane having the formula Si(OSiR⁴₂CH₂CHR³R⁶)₄, (ii) at least one organosiloxane having the formula Si[OSiR⁴₂((CH₂)ₘSiR⁴₂OSiR⁴²)ₙCH₂CHR³R⁶]₄, (iii) at least one organosiloxane having the formula R⁶R³CHCH₂SiR⁴₂OSiR⁴₂CH₂CHR³R⁶, (iv) at least one organosiloxane having the formula R⁶R³CHCH₂SiR⁴₂OSiR⁴₂(CH₂)ₚSiR⁴₂OSiR⁴₂CH₂CHR³R⁶, and (v) a mixture comprising at least two of the preceding organosiloxanes, wherein R³ and R⁴ are as defined and exemplified above for component (A), R⁶ is an epoxy group, m is an even integer having a value of from 2 to 20, n is 1 or 2, and p is an even integer having a value of from 4 to 20.

The epoxy groups represented by R⁶ typically have from 2 to 10 carbon atoms. Examples of epoxy groups include, but are not limited to, groups having the following formulae:

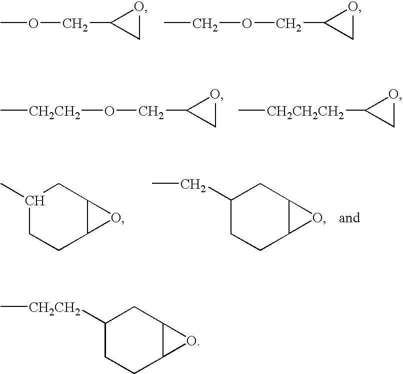

Examples of epoxy-functional organosiloxanes having the formula Si(OSiR⁴₂CH₂CHR³R⁶)₄, wherein R³, R⁴ and R⁶ are as defined and exemplified above, include, but are not limited to, organosiloxanes having the following formulae: 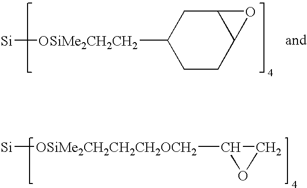
wherein Me is methyl.

Examples of epoxy-functional organosiloxanes having the formula Si[OSiR⁴₂((CH₂)ₘSiR⁴₂OSiR⁴₂)ₙCH₂CHR³R⁶]₄, wherein R³, R⁴, R⁶, m and n are as defined and exemplified above, include, but are not limited to, organosiloxanes having the following formulae: 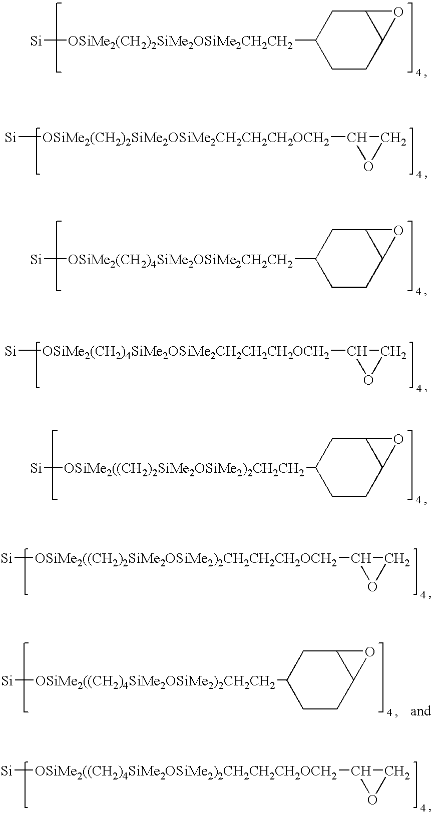
wherein ME is methyl.

Examples of epoxy-functional organosiloxanes having the formula R⁶R³CHCH₂SiR⁴₂CH₂CHR³R⁶, wherein R³, R⁴ and R⁶ are as defined and exemplified above, include, but are not limited to, organosiloxanes having the following formulae: 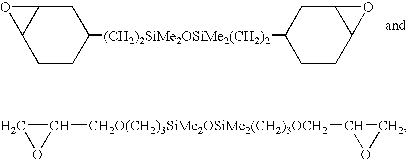
wherein Me is methyl.

Examples of epoxy-functional organosiloxanes having the formula R⁶R³CHCH₂SiR⁴₂OSiR⁴₂(CH₂)ₚSiR⁴₂OSiR⁴₂CH₂CHR³R⁶, wherein R³, R⁴, R⁶, and p are as defined and exemplified above, include, but are not limited to, organosiloxanes having the following formulae: 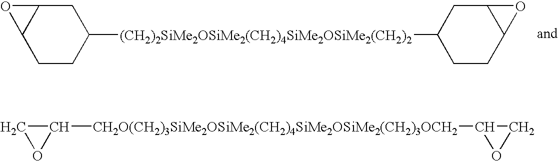
wherein Me is methyl.

Component (B) can be an epoxy-functional organosiloxane selected from (B)(i)-(B)(iv), each as described above, or (B)(v) a mixture comprising at least two of the organosiloxanes (B)(i)-(B)(iv).

The concentration of component (B) in the polyisobutlyene composition of the present invention is typically from 1 to 60% (w/w), alternatively from 5 to 40% (w/w), alternatively form 5 to 20% (w/w), based on the total weight of the composition.

Methods of preparing epoxy-functional organosiloxanes suitable for use as component (B) in the polyisobutlyene composition of the present invention are well known in the art, as exemplified in U.S. Pat. No. 5,387,698, U.S. Pat. No. 5,442,026, U.S. Pat. No. 5,260,399, U.S. Pat. No. 5,169,962, International Publication No. WO 99/26112, and U.S. Publication No. 2002/0068223 A1. For example, organosiloxanes having the formula Si(OSiR⁴₂CH₂CHR³R⁶)₄ can be prepared by reacting a pentasiloxane having the formula Si(OSiR⁴₂H)₄ with an epoxy-functional alkene having the formula R⁶R³C═CH₂ in the presence of a hydrosilylation catalyst and, optionally, an organic solvent, wherein R³, R⁴ and R⁶ are as defined and exemplified above.

Epoxy-functional organosiloxanes having the formula Si[OSiR⁴₂((CH₂)ₘSiR⁴₂OSiR⁴₂)ₙCH₂CHR³R⁶]₄, wherein m=2 and n=1, can be prepared by (1) reacting a disiloxane having the formula HSiR⁴₂OSiR⁴₂H with an epoxy-functional alkene having the formula R⁶R³C═CH₂ in the presence of a hydrosilylation catalyst and, optionally, an organic solvent, to produce an epoxy-functional disiloxane having the formula R⁶R³CHCH₂SiR⁴₂OSiR⁴₂H, and (2) reacting the epoxy-functional disiloxane with a pentasiloxane having the formula Si(OSiR⁴₂CH═CH₂)₄ in the presence of a hydrosilylation catalyst and, optionally, an organic solvent, wherein R³, R⁴ and R⁶ are as defined and exemplified above.

Epoxy-functional organosiloxanes having the formula Si[OSiR⁴₂((CH₂)ₘSiR⁴₂OSiR⁴₂)ₙCH₂CHR³R⁶]₄, wherein m is an even integer having a value of from 4 to 20 and n=1, can be prepared by (1) reacting a disiloxane having the formula HSiR⁴₂OSiR⁴₂H with an epoxy-functional alkene having the formula R⁶R³C═CH₂ in the presence of a hydrosilylation catalyst and, optionally, an organic solvent, to produce an epoxy-functional disiloxane having the formula R⁶R³CHCH₂SiR⁴₂OSiR⁴₂H, (2) reacting the epoxy-functional disiloxane with a diene having the formula H₂C═CH(CH₂)ₘ₋₄CH═CH₂ in the presence of a hydrosilylation catalyst and, optionally, an organic solvent to produce an alkenyl disiloxane having the formula R⁶R³CHCH₂SiR⁴₂OSiR⁴₂(CH₂)ₘ₋₂CH═CH₂, and (3) reacting the alkenyl disiloxane with a pentasiloxane having the formula Si(OSiR⁴ 2H)₄, wherein R³, R⁴ and R⁶ are as defined and exemplified above.

Epoxy-functional organosiloxanes having the formula Si[OSiR⁴₂((CH₂)ₘSiR⁴₂OSiR⁴₂)ₙCH₂CHR³R⁶]₄, wherein m is an even integer having a value of from 2 to 20 and n=2, can be prepared by (1) reacting a disiloxane having the formula HSiR⁴₂OSiR⁴₂H with an epoxy-functional alkene having the formula R⁶R³C═CH₂ in the presence of a hydrosilylation catalyst and, optionally, an organic solvent, to produce an epoxy-functional disiloxane having the formula R⁶R³CHCH₂SiR⁴₂OSiR⁴₂H, (2) reacting the epoxy-functional disiloxane with a diene having the formula H₂C═CH(CH₂)ₘ₋₂SiR⁴₂OSiR⁴₂(CH₂)ₘ₋₂CH═CH₂ in the presence of a hydrosilylation catalyst and, optionally, an organic solvent to produce an alkenyl disiloxane having the formula R⁶R³CHCH₂SiR⁴₂OSiR⁴₂(CH₂)ₘSiR⁴₂OSiR⁴₂(CH₂)ₘ₋₂CH═CH₂, and (3) reacting the alkenyl disiloxane with a pentasiloxane having the formula Si(OSiR⁴₂H)₄, wherein R³, R⁴ and R⁶ are as defined and exemplified above.

Epoxy-functional organosiloxanes having the formula R⁶R³CHCH₂SiR⁴₂OSiR⁴₂CH₂CHR³R⁶, can be prepared by (1) reacting a disiloxane having the formula HSiR⁴₂OSiR⁴₂H with an epoxy-functional alkene having the formula R⁶R³C═CH₂ in the presence of a hydrosilylation catalyst and, optionally, an organic solvent, wherein the mole ratio of the epoxy-functional alkene to the disiloxane is 2:1 and R³, R⁴, and R⁶ are as defined and exemplified above.

Epoxy-functional organosiloxanes having the formula R⁶R³CHCH₂SiR⁴₂OSiR⁴₂(CH₂)ₚSiR⁴₂OSiR⁴₂CH₂CHR³R⁶ can be prepared by (1) reacting a disiloxane having the formula HSiR⁴₂OSiR⁴₂H with an epoxy-functional alkene having the formula R⁶R³C═CH₂ in the presence of a hydrosilylation catalyst and, optionally, an organic solvent, to produce an epoxy-functional disiloxane having the formula R⁶R³CHCH₂SiR⁴₂OSiR⁴₂H, (2) reacting the epoxy-functional disiloxane with a diene having the formula H₂C═CH(CH₂)ₚ₋₄CH═CH₂ in the presence of a hydrosilylation catalyst and, optionally, an organic solvent, wherein the ratio of epoxy-functional disiloxane to the diene is 2:1 and R³, R⁴, R⁶, and p are as defined and exemplified above.

Component (C) is at least one cationic photoinitiator. Examples of cationic photoinitiators include, but are not limited to, onium salts, diaryliodonium salts of sulfonic acids, triarylsulfonium salts of sulfonic acids, diaryliodonium salts of boronic acids, and triarylsulfonium salts of boronic acids.

Suitable onium salts include salts having a formula selected from R⁷₂I⁺MX_{z}^{-, R}⁷₃ S⁺MX_{z}⁻, R⁷₃Se⁺MX_{z}⁻, R⁷₄ P⁺MX_{z}⁻, and R⁷₄ N⁺MX_{z}⁻, wherein each R⁷ is independently hydrocarbyl or substituted hydrocarbyl having from 1 to 30 carbon atoms; M is an element selected from transition metals, rare earth metals, lanthanide metals, metalloids, phosphorus, and sulfur; X is a halo (e.g., chloro, bromo, iodo), and z has a value such that the product z (charge on X+oxidation number of M)=−1. Examples of substituents on the hydrocarbyl group include, but are not limited to, C₁ to C₈ alkoxy, C₁ to C₁₆ alkyl, nitro, chloro, bromo, cyano, carboxyl, mercapto, and heterocyclic aromatic groups, such as pyridyl, thiophenyl, and pyranyl. Examples of metals represented by M include, but are not limited to, transition metals, such as Fe, Ti, Zr, Sc, V, Cr, and Mn; lanthanide metals, such as Pr, and Nd; other metals, such as Cs, Sb, Sn, Bi, Al, Ga, and In; metalloids, such as B, and As; and P. The formula MX_{z}⁻ represents a non-basic, non-nucleophilic anion. Examples of anions having the formula MX_{z}⁻ include, but are not limited to, BF₄⁻, PF₆⁻, AsF₆⁻, SbF₆^{═}, SbCl₆⁻, and SnCl₆⁻.

Examples of onium salts include, but are not limited to, bis-diaryliodonium salts, such as bis(dodecyl phenyl)iodonium hexafluoroarsenate, bis(dodecylphenyl)iodonium hexafluoroantimonate, and dialkylphenyliodonium hexafluoroantimonate.

Examples of diaryliodonium salts of sulfonic acids include, but are not limited to, diaryliodonium salts of perfluoroalkylsulfonic acids, such as diaryliodonium salts of perfluorobutanesulfonic acid, diaryliodonium salts of perfluoroethanesulfonic acid, diaryliodonium salts of perfluorooctanesulfonic acid, and diaryliodonium salts of trifluoromethanesulfonic acid; and diaryliodonium salts of aryl sulfonic acids, such as diaryliodonium salts of para-toluenesulfonic acid, diaryliodonium salts of dodecylbenzenesulfonic acid, diaryliodonium salts of benzenesulfonic acid, and diaryliodonium salts of 3-nitrobenzenesulfonic acid.

Examples of triarylsulfonium salts of sulfonic acids include, but are not limited to, triarylsulfonium salts of perfluoroalkylsulfonic acids, such as triarylsulforium salts of perfluorobutanesulfonic acid, triarylsulfonium salts of perfluoroethanesulfonic acid, triarylsulfonium salts of perfluorooctanesulfonic acid, and triarylsulfonium salts of trifluoromethanesulfonic acid; and triarylsulfonium salts of aryl sulfonic acids, such as triarylsulfonium salts of para-toluenesulfonic acid, triarylsulfonium salts of dodecylbenzenesulfonic acid, triarylsulfonium salts of benzenesulfonic acid, and triarylsulfonium salts of 3-nitrobenzenesulfonic acid.

Examples of diaryliodonium salts of boronic acids include, but are not limited to, diaryliodonium salts of perhaloarylboronic acids. Examples of triarylsulfonium salts of boronic acids include, but are not limited to, triarylsulfonium salts of perhaloarylboronic acid. Diaryliodonium salts of boronic acids and triarylsulfonium salts of boronic acids are well known in the art, as exemplified in European Patent Application No. EP 0562922.

Component (C) can be a single cationic photoinitiator or a mixture comprising two or more different cationic photoinitiators, each as defined above. The concentration of component (C) is typically from 0.01 to 5% (w/w), alternatively from 0.1 to 2% (w/w), based on the total weight of the polyisobutylene composition.

The polyisobutylene composition of can contain additional ingredients, provided the ingredient does not adversely affect the physical properties, particularly modulus, tensile strength, and adhesion, of the cured product. Examples of additional ingredients include, but are not limited to, organic reactive diluents, such as the reactive diluents disclosed in U.S. Patent Pub. No. 2002/0028303 A1; light stabilizers; sensitizers; antioxidants; fillers, such as reinforcing fillers, extending fillers, and conductive fillers; adhesion promoters; and fluorescent dyes.

The polyisobutylene composition can be a one-part composition comprising component (A)-(C) in a single part or, alternatively, a multi-part composition comprising components (A)-(C) in two or more parts.

The polyisobutylene composition of the instant invention is typically prepared by combining components (A), (B), and (C) and any optional ingredients in the stated proportions at ambient temperature. Mixing can be accomplished by any of the techniques known in the art such as milling, blending, and stirring, either in a batch or continuous process. The particular device is determined by the viscosity of the components and the viscosity of the polyisobutylene composition.

A cured polyisobutylene product according to the present invention is prepared by curing the polyisobutylene composition, described above. The composition can be cured by exposing it to radiation. The radiation typically has a wavelength of from 250 to 400 nm. The dose of radiation is typically from 50 to 1,000 mJ/cm², alternatively from 200 to 500 mJ/cm².

The polyisobutylene composition of the present invention can be conveniently formulated as a one-part composition. Moreover, the polyisobutylene composition has good shelf-stability in the absence of light. Importantly, the composition can be applied to a substrate by convention high-speed methods such as spin coating, printing, and spraying. Also, the polyisobutylene composition cures rapidly upon exposure to radiation, e.g., ultraviolet light.

The cured polyisobutylene product prepared by curing the polyisobutylene composition of the present invention exhibits properties characteristic of both silicones and polyisobutylenes. For example, the cured polyisobutylene product exhibits high oil resistance (low oil swell), high tensile strength, high modulus, low surface tack, and low permeability to water and oxygen. Moreover, the cured polyisobutylene product has good primerless adhesion to a variety of substrates, good optical clarity at low wavelengths, and high thermal stability.

The polyisobutylene composition of the present invention, which forms a cured polyisobutylene product, has numerous uses, including protective coatings, encapsulants, and adhesives. In particular, the polyisobutylene composition is useful for bonding components in electronic or electro-optic devices to flexible or rigid substrates

### EXAMPLES

The following examples are presented to better illustrate the polyisobutylene composition of the present invention, but are not to be considered as limiting the invention, which is delineated in the appended claims. Unless otherwise noted, all parts and percentages reported in the examples are by weight. The following methods and materials were employed in the examples:

NMR Spectra

Nuclear magnetic resonance spectra (¹HNMR, ²⁹Si NMR) were obtained using a Varian Mercury 300 or 400 MHz NMR spectrometer. The sample (0.5-1.0g) was dissolved in 2.5-3 mL of chloroform-d for ¹HNMR, or in a solution of Cr(acac)₃ in chloroform-d (0.04 M) for ²⁹SiNMR. The chemical shift values (6) reported in the examples are in units of parts per million (ppm), measured relative to tetramethylsilane in the ²⁹Si NMR spectra.

Determination of Molecular Weights

Number-average and weight-average molecular weights (Mₙ and M_{w}) were determined by gel permeation chromatography (GPC) using a PLgel (Polymer Laboratories, Inc.) 5-μm column at room temperature (˜23° C.), a THF mobile phase at 1 mL/min, and a refractive index detector. Polyisobutylene standards were used for linear regression calibrations.

Measurement of Tensile Strength and Elongation

Test samples were prepared by casting the polyisobutylene composition on a glass microscope slide to form a film having a thickness of from 75 to 250 μM and exposing the film to ultraviolet radiation until the cured product was dry to touch. The dose of radiation, which varied with film thickness, was typically from 200 to 500 mJ/cm².

Tensile strength at ultimate elongation and ultimate elongation of a cured polyisobutylene test specimen were determined using a Monsanto Tensiometer 2000 according to ASTM Standard D 412. The rate of grip separation was 20 in./min (0.85 cm/s). Chord modulus was calculated from the stress-strain curve using the method described in ASTM Standard E 111-97. Reported values for tensile strength (MPa) and elongation (%) each represent the average of three measurements made on different dumbbell-shaped test specimens from the same test specimen.

Reagents

The following chemical substances were used in the examples:
1,4-Cyclohexanedimethanol divinyl ether, dodecyl vinyl ether, and 4-hydroxybutyl vinyl ether were purchased from International Specialty Chemicals (Wayne N.J.).

Heloxy® Modifier 64, which is sold by Resolution Performance Products (Houston, Tex.), is nonylphenyl glycidyl ether having the formula:

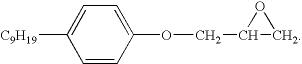

Irganox® 1135, which is sold by Ciba Specialty Chemicals (Tarrytown N.Y.), is a hindered phenolic antioxidant consisting of C₇-C₉ branched alkyl esters of 3,5-bis(1,1-dimethylethyl)₄-hydroxybenzenepropionic acid, for example:

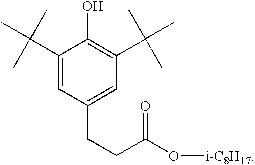

Tinuvin® 123, which is sold by Ciba Specialty Chemicals (Tarrytown N.Y.), is a light stabilizer consisting of reaction products of bis(2,2,6,6-tetramethyl-4-piperidinyl)decane-dioate, having the formula: 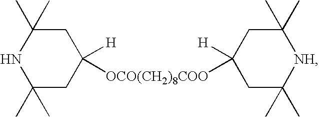
with 1,1-dimethylethylhydroperoxide and octane.

Chivacure 184, which is sold by Chitec Chemical Co., LTD. (Taipei, Taiwan), is 1-hydroxycyclohexyl phenyl ketone.

UV9385C, which is sold by Craig Adhesives & Coatings Company (Newark, N.J.), consists of 30 to 60% (w/w) of C₁₂ and C₁₄ alkylglycidyl ethers and 30 to 60% (w/w) of bis(4-dodecylphenyl)iodonium hexafluouroatimonate.

Trilaurylamine was purchased from Aldrich Chemical Co. (Milwaukee, Wis.).

Tyzor TPT, which is sold by Dupont (Wilmington, Del.), is tetra-isopropyl titanate having the formula (1-C₃H₇O)₄Ti.

Base Mix is a mixture consisting of 20.349 g of 1,4-cyclohexanedimethanol divinyl ether, 6.783 g of Heloxy® Modifier 64, 1.356 g of Chivacure® 184, 1.356 g of UV9385C, 0.135 g of Irganox® 1135, 0.010 g of Tinuvin® 123, 0.010 g of trilaurylamine.

Epion® 100S, which is sold by Kaneka Corporation (Osaka, Japan), is a dimethoxymethylsilylpropyl-terminated polyisobutylene (PIB) polymer having a viscosity of 731 Pa·s, a number-average molecular weight of 5,578, a weight-average molecular weight of 9048, and a polydispersity of 1.622.

### Example 1

100721 Epion 100 S (450 g), 33.4 grams of 4-hydroxybutyl vinyl ether, and 38 g of dodecyl vinyl ether were combined under nitrogen in a one-quart Ross mixer (Charles Ross & Sons Co., Haupauge, N.Y.) equipped with dispersion and planetary blades. The combination was mixed using dispersion and planetary blade speeds of 500 rpm and 23 rpm, respectively, and heated to a temperature of 50° C. To the mixture was added a solution consisting of 7 g of dodecyl vinyl ether and 0.23 grams of Tyzor® TPT. After 5 min, the dispersion and planetary blade speeds were increased to 1003 rpm and 40 rpm, respectively. The mixture was heated to 150° C., a vacuum was applied to system, and methanol was collected in a trap cooled in dry ice/isopropyl alcohol. After 4 hours, the mixture was allowed to cool to room temperature.

The ²⁹SiNMR spectrum of the product shows signals at 3.6-4.2 ppm and 6.4 ppm corresponding to the —SiMe(OCH₂CH₂ CH₂CH₂ OCH═CH₂)₂ groups and signals at 3.4 ppm corresponding to —SiMeOMe2 groups. From the integration values for these peaks the percent of methoxysilyl groups converted to vinyl ether groups was estimated at greater than 85 mol %. The polymer had a number-average molecular weight of 6500, a weight-average molecular weight of 6500, and a polydispersity of 9300, and a MWD of 1.43.

### Example 2

Tetrakis(dimethylsiloxy)silane (4.6019 g) and 12.0 mL of toluene were combined under argon in a dry 250-mL three-neck flask equipped with a magnetic stirrer, addition funnel, thermometer, and a condenser. A solution consisting of 1.0 mg of 1,3-divinyl-1,1,3,3-tetramethyldisiloxane (Karstedt catalyst) in 1.0 mL toluene was added to the mixture. Next, 20.56 g of 1,1,3,3-tetramethyl-1-oct-7-enyl-3-[2-(7-oxabicyclo[4.1.0]hept-3-yl)ethyl]disiloxane, synthesized according to literature methods (Crivello, et al., Polym. Prepr. Am. Chem. Soc., Div. Polym. Chem. 1991, 32(3), 173-4; and Crivello, et al., J Polym Sci., Part A: Polym. Chem. 1993, 31(10), 2563-2572), was added to the mixture at a temperature of from 32 to 36° C. during a period of 1 h. Additional catalyst solution (1.5 mg) and 0.5 g of 1,1,3,3-tetramethyl-1-oct-7-enyl-3-[2-(7-oxa-bicyclo[4.1.0]hept-3-yl)-ethyl]disiloxane were added to the reaction mixture. The mixture was stirred at 40° C. until FTIR analysis revealed the Si—H content of a sample was no longer discernable. The reaction mixture was diluted with 100 mL of hexanes and treated with activated charcoal. The charcoal was removed by filtration and the filtrate was concentrated under reduced pressure using a rotary evaporator. The residue was kept under high vacuum for 17 h to give a tetrafunctional epoxy monomer (24.86 g, 98%) having the following formula:

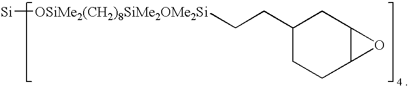

### Example 3

A solution consisting of 0.2% of rhodium(I) tris(triphenylphosphine) chloride (Wilkinson's catalyst) and 99.8% anhydrous toluene was mixed in a vial and warmed to 50° C. for 5 minutes. The catalyst solution (6.69 g) was added to 4,511 g of tetramethyldisiloxane under nitrogen in a 12-L, 3-neck flask equipped with an addition funnel, condenser, and mechanical stirrer. The mixture was heated to 69° C. and 3,120 g of 1,2-epoxy-4-vinylcylcohexane was added drop-wise to the mixture during a period of 6.5 h. The temperature was maintained between about 65 and 74° C. by controlling the rate of addition of 1,2-epoxy-4-vinylcylcohexane, application of external heat, and air-cooling. After the addition was complete, the mixture was heated at 70° C. for 1 h and then allowed to cool to 35° C. The mixture was treated with activated charcoal (100 mesh) and then stirred overnight at room temperature under nitrogen. The mixture was then filtered through a membrane (0.45 μm) to remove the charcoal. The filtrate was distilled under vacuum (18.7 Pa) at a temperature of 99 to 104° C. to give a monoepoxy siloxane product having the following formula, as determined by ¹HNMR and ²⁹SiNMR:

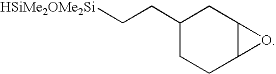

A solution (8.01 g) consisting of 2.01 g of a platinum complex of 1,3-divinyl-1,1,3,3-tetramethyldisiloxane and 99 g of anhydrous toluene was added to 3,102 g of 1,7-cctadiene under nitrogen at 48° C. The preceding monoexpoxy siloxane product (2,303 g) was added drop-wise to the mixture during a period of 4 h. The temperature of the mixture was maintained between 47 and 50° C. by controlling the rate of addition and air-cooling. After the addition was complete, the mixture was stirred for 1 h and then allowed to cool to 35° C. The mixture was treated with activated charcoal (131 g) and then stirred overnight at room temperature. The mixture was then filtered through a membrane (0.45 μm) to remove the charcoal. The filtrate was distilled under vacuum to remove unreacted starting materials to give a product having the following composition, as determined by ¹HNMR and ²⁹SiNMR:

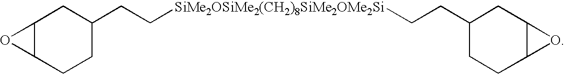

### Examples 4a-d

In each of examples 4a-d, a polyisobutylene composition was prepared by combining Epion 100S®, Base Mix, and Epoxy compound E-1 or Epoxy compound E-2 in the amounts specified in Table 1. The components were blended using a Hauschild mixer until a homogeneous composition was obtained. The tensile strength and elongation of the cured polyisobutylene products are shown in Table 2.

TABLE 1

Mass of Component (g)
Example

| Component | 4a | 4b | 4c | 4d |
|---|---|---|---|---|
| Epion 100S ® | 15.18 | 11.58 | 15.18 | 11.58 |
| Base Mix | 4.42 | 4.42 | 4.42 | 4.42 |
| E-1 | 0.40 | 4.00 | — | — |
| E-2 | — | — | 0.40 | 4.00 |

— denotes absence of component in composition.

TABLE 2

| | Tensile Strength | Elongation |
|---|---|---|
| Example | (MPa) | (%) |
| 4a | 3.59 | 42 |
| 4b | 3.74 | 44 |
| 4c | 5.75 | 35 |
| 4d | 4.67 | 35 |

1. A polyisobutylene composition, comprising:
(A) a polyisobutylene polymer selected from (i) a glycidoxy-functional polyisobutylene polymer containing an average of at least two glycidoxy groups per molecule having the formula —O—CH₂CH(O)CH₂ and (ii) an alkenyl ether-functional polyisobutylene polymer containing an average of at least two alkenyl ether groups per molecule having the formula —SiR¹_{a[OR}²OC(R³)═CH(R³)]₃₋ₐ, wherein each R¹ is independently C₁ to C₁₀ hydrocarbyl, C₁ to C₁₀ halogen-substituted hydrocarbyl, or C₁ to C₈ alkoxy, R² is C₁ to C₁₀ hydrocarbylene or C₁ to C₁₀ halogen-substituted hydrocarbylene, each R³ is independently C₁ to C₁₀ hydrocarbyl, C₁ to C₁₀ halogen-substituted hydrocarbyl, or —H, subscript a is an integer having a value of 0, 1, or 2, and at least 50 mol % of the repeat units in the polyisobutylene polymer are isobutylene units having the formula: —CH₂C(CH₃)₂—;
(B) an epoxy-functional organosiloxane containing from 0.5 to 20% (w/w) silicon, an average of at least two siloxane linkages per molecule, and an average of at least two epoxy groups per molecule; and
(C) a catalytic amount of a cationic photoinitiator.

2. The polyisobutylene composition according to claim 1, wherein at least 60 mol % of the repeat units in the polyisobutylene polymer are isobutylene units.

3. The polyisobutylene composition according to claim 1, wherein the polyisobutylene polymer of component (A) is a glycidoxy-functional polyisobutylene polymer containing an average of at least two glycidoxy groups having the formula —O—CH₂CH(O)CH₂ per molecule.

4. The polyisobutylene composition according to claim 1, wherein the polyisobutylene polymer of component (A) is an alkenyl ether-functional polyisobutylene polymer containing an average of at least two alkenyl ether groups having the formula —SiR¹ₐ[OR²OC(R³)═CH(R³)]₃₋ₐ per molecule, wherein each R¹ is independently C₁ to C₁₀ hydrocarbyl, C₁ to C₁₀ halogen-substituted hydrocarbyl, or C₁ to C₈ alkoxy, R² is C₁ to C₁₀ hydrocarbylene or C₁ to C₁₀ halogen-substituted hydrocarbylene, each R³ is independently C₁ to C₁₀ hydrocarbyl, C₁ to C₁₀ halogen-substituted hydrocarbyl, or —H, and subscript a is an integer having a value of 0, 1, or 2.

5. The polyisobutylene composition according to claims 4, wherein R² is alkylene.

6. The polyisobutylene composition according to claim 1, wherein the concentration of component (A) is from 30 to 80% (w/w), based on the total weight of the composition.

7. The polyisobutylene composition according to claim 1, wherein the epoxy-functional organosiloxane contains from 1 to 10% (w/w) of silicon, based on the total weight of the organosiloxane.

8. The polyisobutylene composition according to claims 1, 3 or 4, wherein the epoxy-functional organosiloxane is selected from (i) at least one organosiloxane having the formula Si(OSiR⁴₂CH₂CHR³R⁶)₄, (ii) at least one organosiloxane having the formula Si[OSiR⁴₂((CH₂)ₘSiR⁴₂OSiR⁴²)ₙCH₂CHR³R⁶]₄, (iii) at least one organosiloxane having the formula R⁶R³CHCH₂SiR⁴₂OSiR⁴₂CH₂CHR³R⁶, (iv) at least one organosiloxane having the formula R⁶R³CHCH₂SiR⁴₂OSiR⁴₂(CH₂)ₚSiR⁴₂OSiR⁴₂CH₂CHR³R⁶, and (v) a mixture comprising at least two of the preceding organosiloxanes,, wherein each R³ is independently C₁ to C₁₀ hydrocarbyl, C₁ to C₁₀ halogen-substituted hydrocarbyl, or —H, each R⁴ is independently C₁ to C₁₀ hydrocarbyl or C₁ to C₁₀ halogen-substituted hydrocarbyl, R⁶ is an epoxy group, m is an even integer having a value of from 2 to 20, n is 1 or 2, and p is an even integer having a value of from 4 to 20.

9. The polyisobutylene composition according to claim 1, wherein the concentration of component (B) is from 5 to 40% (w/w), based on the total weight of the composition.

10. A cured polyisobutylene product prepared by curing the polyisobutylene composition according to claim 1.

11. A cured polyisobutylene product prepared by curing the polyisobutylene composition according to claim 3.

12. A cured polyisobutylene product prepared by curing the polyisobutylene composition according to claim 4.

13. A cured polyisobutylene product prepared by curing the polyisobutylene composition according to claim 8.
